(19) United States
(12) Patent Application Publication
(10) Pub. No.: US 2017/0199639 A1
(43) Pub. Date: Jul. 13, 2017

(54) CONTENT NAVIGATION CONTROL

(71) Applicant: Microsoft Technology Licensing, LLC, Redmond, WA (US)

(72) Inventors: Kenton O'Hara, Bristol (GB); Samuel Gavin Smyth, Huntingdon (GB); Edward Sean Lloyd Rintel, Cambridge (GB); Debaleena Chattopadhyay, Indianapolis, IN (US)

(21) Appl. No.: 14/990,183

(22) Filed: Jan. 7, 2016

(51) Int. Cl. G06F 3/0484; H04L 29/06

(52) U.S. Cl. CPC G06F 3/0484; H04L 65/4015; H04L 65/4046

(57) ABSTRACT

A computing device is described comprising a navigation component configured to receive navigation data from a presenter host device. The navigation data is about navigation of a plurality of content views as part of a presentation of the content views being controlled by the presenter host device. The navigation component is configured to enter an audience interactive mode when it receives data from the presenter host device indicating availability of the audience interactive mode. The navigation component, is configured when in the audience interactive mode, to send instructions to the presenter host device to control the navigation of the plurality of content views on the basis of user input received at the computing device.

### BACKGROUND

Content views such as slides of a slide presentation, pages of a web site, pages of an electronic book, images of a social media site, or other content views are typically navigated by a user under his or her control. For example, by advancing or reversing slides in a slide show of a presentation application, by browsing web pages, by advancing pages of an electronic book and so on. However, where the content views are part of a shared experience, for example, as part of an online lecture, as part of a presentation given in a physical lecture room, as part of an online tutorial or demonstration, the navigation is achieved by a single user such as the lecturer, demonstrator or teacher.

The embodiments described below are not limited to implementations which solve any or all of the disadvantages of known content navigation control systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A computing device is described comprising a navigation component configured to receive navigation data from a presenter host device. The navigation data is about navigation of a plurality of content views as part of a presentation of the content views being controlled by the presenter host device. The navigation component is configured to enter an audience interactive mode when it receives data from the presenter host device indicating availability of the audience interactive mode. The navigation component, is configured when in the audience interactive mode, to send instructions to the presenter host device to control the navigation of the plurality of content views on the basis of user input received at the computing device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1A is a schematic diagram of navigation of content views by a presenter in a lecture room;

FIG. 1B is a schematic diagram of navigation of content views by a pair of presenters in an online lecture room;

FIG. 2 is a schematic diagram of a presenter host device, a public display and two communications devices;

FIG. 3 is a schematic diagram of a state machine of a navigation component;

FIG. 4 is a message sequence chart depicting an example message sequence between a presenter host device, an individual presenter device and an audience device;

FIG. 5 illustrates an exemplary computing-based device in which embodiments of a presenter host device or an individual presenter device, or an audience device are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Navigation of content views during a shared presentation of the content views, is typically limited to a single presenter such as a teacher, lecturer or demonstrator. Access to and control of the public display of content views such as slides is typically under the control of one user, which precludes both audience private review of the content views as well as audience control of the public display. However, there is often a need to allow those viewing the shared presentation to be more than mere passive receivers of the content. For example, to enable an audience member to take over control of navigation of the presented content views. This is useful where the audience member wants to revert slides of a shared presentation to an earlier slide, in order to ask a question about that slide for example. However, it is not straightforward to enable audience members to take over control of navigation in a manner which is efficient or robust or easy to use.

The present technology provides an efficient technical solution for controlling navigation of content views, such that navigation is achieved by audience members as well as one or more presenters. The solution is versatile since a small number of states of a state machine enable a lot of scenarios to be implemented. The solution is efficient because it explicitly reduces ‘interaction cost’ of the user, presenter or audience members, to control the shared public display and review documents privately. By reducing cost of interaction, it is meant not making higher investments, such as setting up a dedicated presentation room with high-end hardware and software, gathering prior information about audience members, physically relocating within a room, or spending a non-trivial amount of time uploading, sharing, and assigning permissions to documents. Instead the present technology upholds the ‘bring your own device’ paradigm, thus leveraging users' familiarity and making interactions with the system efficient. The technology is found to be robust to failure since loss of communication from individual audience devices is accommodated whilst enabling the presenter host device to continue. The technology is easy to use by audience members and presenters because of use of one or more modes or states of a navigation component at each audience device and at the presenter host device, for example, a review mode and an interaction mode (described in detail below). A navigation component is in one of the specified modes or states and a particular state limits how the navigation component is able to operate. By using states and controlling transitions between states at audience devices the technology enables control of navigation of the content views to be given to and used by audience members and removed from audience members. Communications devices are able to transition between states designed for presenters and states designed for audience members in a dynamic manner throughout a presentation.

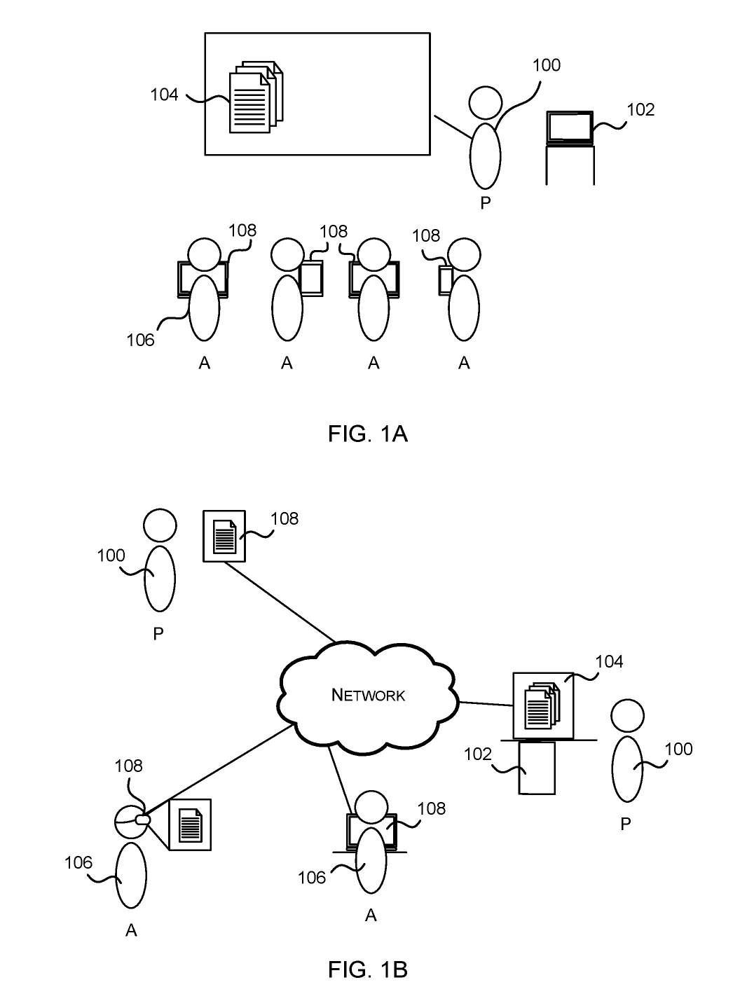

FIG. 1 is a schematic diagram of navigation of content views 104 by a presenter 100 in a lecture room. A content view is any graphical, image, audio or text data which may be presented in a display. A non-exhaustive list of examples of a content view is: a slide of a slide presentation, a page of a web site, a post of a blog, an email, an image of a social media site, a video clip, a page of an electronic book. In the example of FIG. 1 the content views 104 are slides of a slide presentation being shown on a large display screen in the lecture room controlled by a laptop of the presenter 100 (denoted P in FIG. 1) referred to as a presenter host device 102. Members of the audience 106 (denoted A in FIG. 1) have individual communications devices 108 such as laptop computers, smart phones, tablet computers, wearable computers and others.

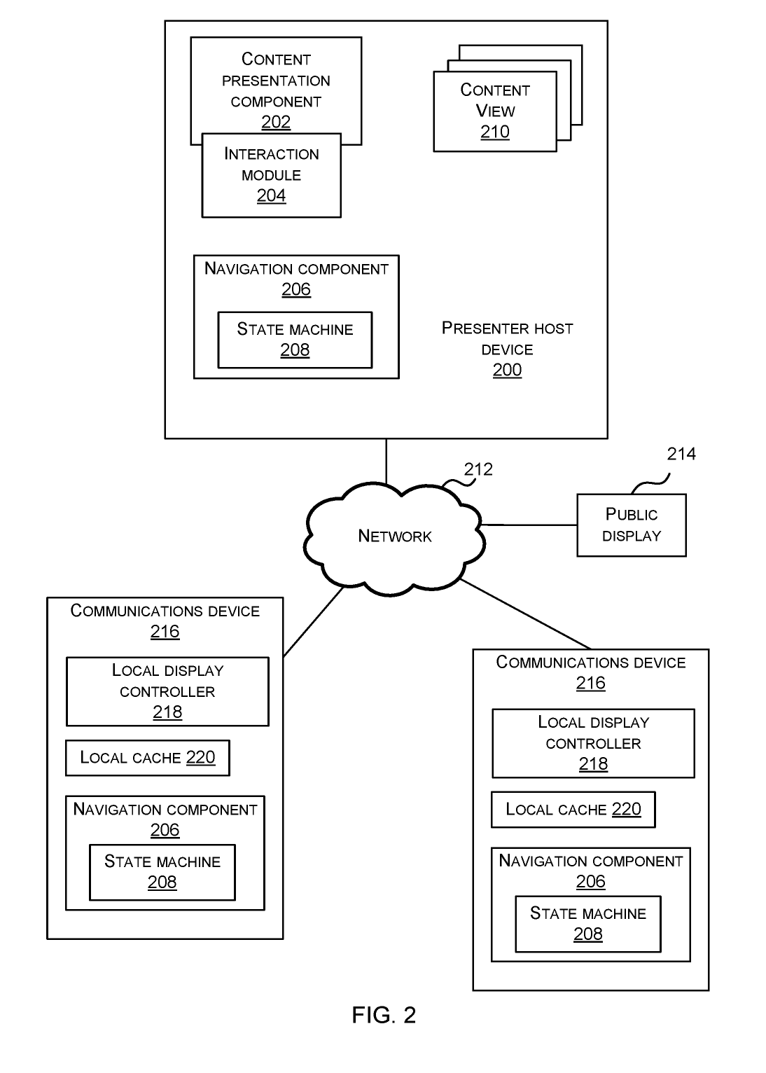

The presenter host device 102 stores the content views 104 and displays the content views 104 on the large display screen using a content presentation component described in more detail with respect to FIG. 2. The presenter 100 uses the presenter host device 102 to navigate the content views 104 for example by advancing or reversing the slides using the content presentation component. In some examples the presenter 100 has a smart phone, wearable computer, or other mobile computing device which communicates with the presenter host device 102 and which he or she uses to navigate the content views 104.

The audience communication devices 108 are in communication with the presenter host device 102. For example, an individual audience communication device 108 establishes a local wireless communications link with the presenter host device 102. The individual audience communication device stores the content views 102 in a local cache at the individual audience communication device in some examples (however, this is not essential). Individual audience members are able to privately review the content views 104 at the audience communication devices 108 in some examples. That is, an audience member can advance or reverse a private view of the content views 104 displayed on his or her communications device 108 independently of the content view navigation by the presenter 100 visible at the public display. This is achieved by using the content views 102 in the local cache in some examples. However, it is also possible for the content views 102 to be streamed to the audience communication device 108 on demand using a wired or wireless communication link.

The presenter 100 is able to grant navigation control (of the content views 104 on the lecture room display) to one or more of the audience members. The presenter 100 is able to resume exclusive navigation control of the content views 104 on the lecture room display. This is achieved through the use of a navigation component at individual ones of the audience communication devices and at the presenter host device. In the case that the presenter has an individual device that communicates with the presenter host device 102, the individual device also has a navigation component.

FIG. 1B is a schematic diagram of navigation of content views 104 by a pair of presenters 100 in an online lecture room. In this example an online lecture is being made to audience members (denoted A in FIG. 1B) by presenters (denoted P in FIG. 1B). Although two presenters are shown in this examples it is possible to have more than two presenters or to have one presenter (as in FIG. 1A.) Individual parties to the online lecture have communications devices 108, 102 connected to one another via a communications network. A presenter host device 102 stores a plurality of content views which the presenters 100 are able to navigate such that the results of the navigation are visible at audience communication devices 108 such as tablet computers, laptop computers, wearable computers, desktop computers and others. A presenter 100 is able to grant navigation control (of the shared content views 104 of the online lecture) to one or more of the audience members. A presenter 100 communications device is able to remove the ability to control navigation of the shared content views 104 of the online lecture from the audience communication devices 108. This is achieved through the use of navigation components at the communications devices 108, 102 as explained in more detail below.

FIG. 2 is a schematic diagram of a presenter host device 200, a public display 214 and two communications devices 216. The presenter host device is computer implemented using any of software, firmware and hardware. For example, it is implemented at the laptop computer 102 in the example of FIG. 1A, at a personal desktop computer 102 in the example of FIG. 1B or at any other computing device. The presenter host device has a memory storing a plurality of content views 210 and it has a content presentation component 202 which enables display of the content views 210 at public display 214 or at any other display or displays such that audience members are able to view the content views in an order specified by a presenter. The content presentation component 202 enables a presenter to navigate the content views; that is, to control the order in which the content views are presented at the public display 214 or any other display or displays visible by audience members. In some examples the content presentation component has functionality to enable authoring of content views.

A presenter is any user operating one of the communications devices 216 or the presenter host device 200, where that device has a navigation component 206 in a presenter role. The presenter role is described in more detail below.

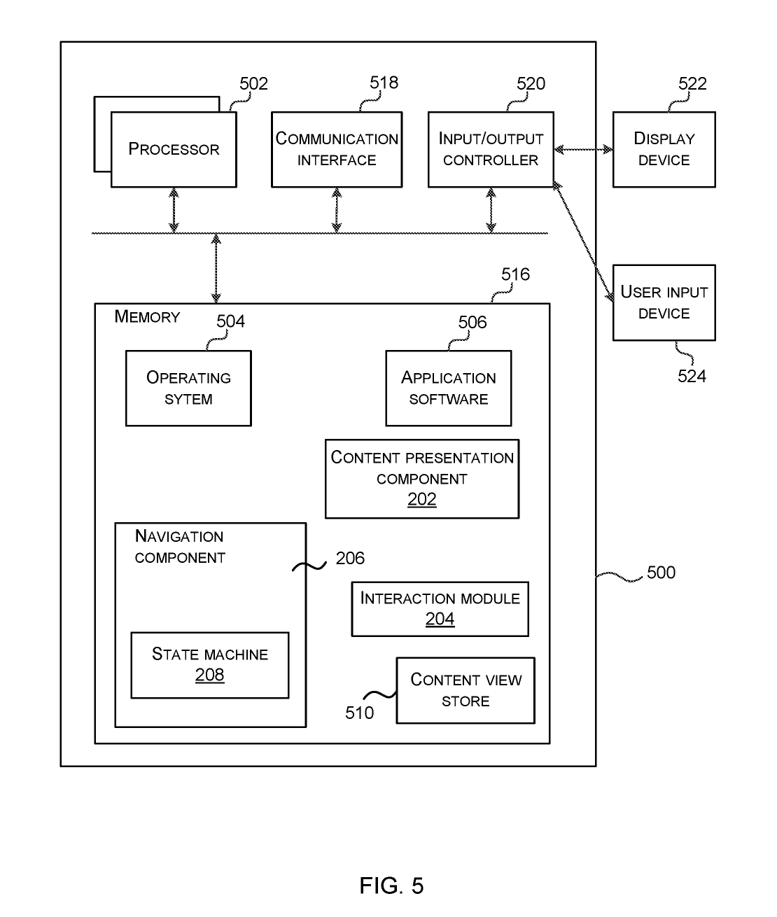

The presenter host device 200 has an interaction module 204 which is an interface between a navigation component 206 and the content presentation component 202. The interaction module has functionality to enable a presenter to select one or more audience interaction capabilities with respect to specified content views. For example, to allow audience members to mark a content view, to take a snapshot of a content view, to comment on a content view, to privately review content views by navigation independently of the presenter at a local audience device. In some examples the interaction module is a software add-in of the content presentation component 202. However, this is not essential; the interaction module is computer implemented using any one or more of software, hardware, firmware. FIG. 2 shows some but not all components of the presenter host device for clarity. The presenter host device is implemented using a computing device such as that of FIG. 5.

The navigation component 206 of the presenter host device is the same as a navigation component 206 at each of the individual communications devices 216 such as audience communication devices and a presenter's individual communication device which communicates with the presenter host device. FIG. 2 shows two communications devices 216 although in practice there are one or more communications devices 216. For example, in the situation of FIG. 1 there are four communications devices but there are possibly several tens or hundreds of communications devices for larger lectures. In the online lecture scenario of FIG. 2 there is a potentially large range of numbers of communications devices, from one to thousands or millions.

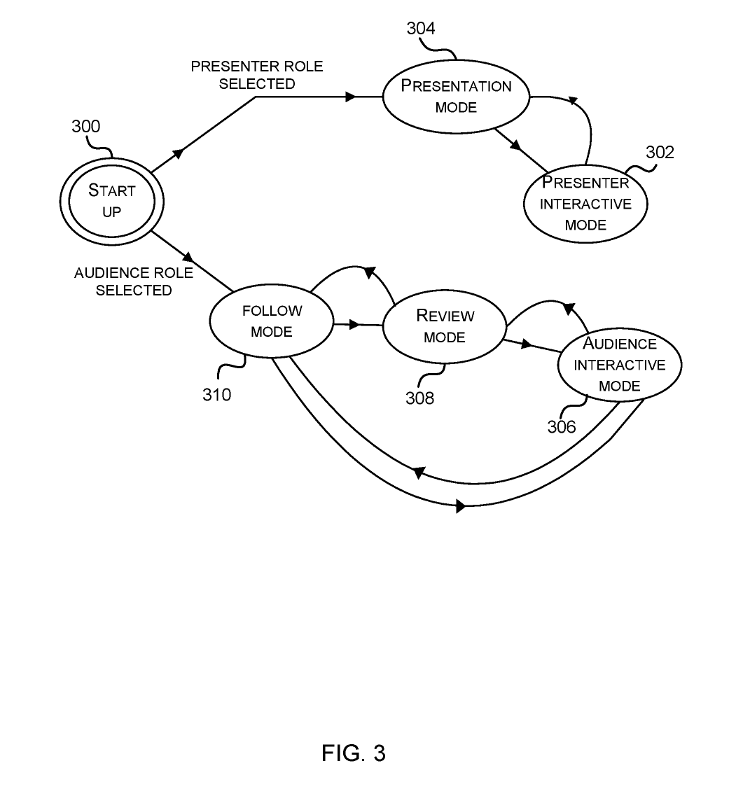

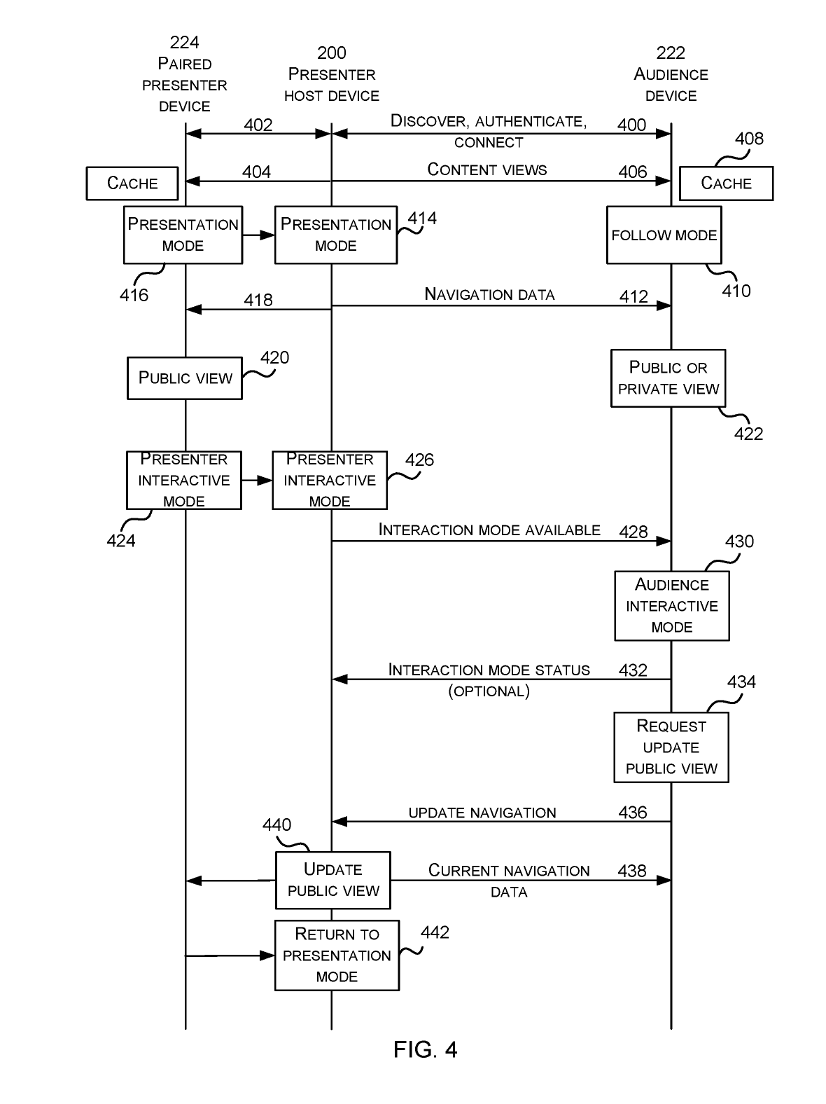

An individual navigation component 206 comprises a state machine 208 which is described in more detail with respect to FIG. 3 below. The state machine controls which states (also referred to as modes or roles in this document) that the navigation component is in, and transitions between those states. The navigation component is configured to instruct the local display controller 218 to display one or more of the content views at a local display associated with the communications device 216. The navigation component generates instructions according to user input received at the communications device and according to current state of state machine 208 of the navigation component. The navigation component communicates with the presenter host device 200 in order to obtain content views 210 from the presenter host device, obtain navigation data from the presenter host device 200 and to communicate control messages with the presenter host device regarding states of the navigation component. This is described in more detail with reference to FIG. 4.

An individual communications device 216 comprises a communications interface to enable the communications device 216 to communicate at least with the presenter host device 200 via communications network 212. For example, the communications network 212 is one or more wired or wireless communications networks such as a local area wireless network, a packet-based network, a public switched telephone network and others. For example, the communications interface is a network card, a wireless communications transceiver, or other communications interface.

In some examples, an individual communications device 216 has a local display controller 218 which is a graphics card or other controller to output the content views 210, or information about the content views, to a display local to the communications device 216. The local display is a multi-touch sensitive screen of the communications device 216 in some examples. The local display is a virtual or augmented reality display generated by a headset in some examples. The local display is a display of a wrist worn computing device or other body worn computing device in some examples. The local display is any display controlled by the local display controller 218. In cases where the local display is too small to show the content views, data about the content views such as a slide number, is shown.

In some examples the individual communications device 216 has no local display controller 218. For example, the individual communications device is a device with no screen which allows back and forward control of the main display during an interaction mode (described in more detail later in this document).

An individual communications device 216 has a local cache 220 which is a memory able to store one or more content views. An individual communications device has a user interface configured to receive user input for navigating the content views and to select modes and roles in some examples. An individual communications device has other components as described with reference to FIG. 5 such as one or more processors, an operating system, application software, an input/output controller.

Alternatively, or in addition, the functionality of the presenter host device 200 and the communications devices 216 described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (AS SPs), System-on-a-chip systems (SOCs), Complex Programmable Logic Devices (CPLDs), Graphics Processing Units (GPUs)

FIG. 3 is a schematic diagram of a state machine 208 of a navigation component 206. At start-up 300 of a communications device 216 or a presenter host device 200, the state machine 208 begins in start-up state 300 which is an end point of the state machine and so indicated with a double circle. In this state the device waits to receive user input selecting either a presenter role an audience role.

If user input is received selecting a presenter role, and optionally if a verification step succeeds, the state machine moves to the presentation mode 304. In the presentation mode 304 the device waits to receive user input specifying how to navigate the content views 210 or whether to move to an interactive mode 306. If it receives user input specifying how to navigate the content views it sends a message to the presenter host device 200 to advance/reverse the content views as described in more detail with reference to FIG. 3. The navigation is linear or non-linear where linear navigation is advancing or reversing the content views one by one according to an order of the content views, and non-linear navigation includes jumping to content views without advancing or reversing one by one. In some examples, in the presentation mode 304, a user is able to manipulate a pointer at a graphical user interface of the communications device to control a corresponding pointer on the shared display. In a presentation mode 304 a user is able to view notes associated with the content views at a local display of the communications device.

During presentation mode 304 if the device receives user input specifying to move to a presenter interactive mode 302 it moves to the presenter interactive mode 302 and a message is sent to the audience communication devices 216 as described in more detail with reference to FIG. 3. Once in the presenter interactive mode 302 the state is able to transition back to the presentation mode 304 if user input is received at the device indicating to do so. During presenter interactive mode 302, if user input (from a presenter) is received at the device specifying to navigate the content views, then the content views at a shared display controlled by the presenter host device 200 are updated accordingly (in a similar manner as during presentation mode 304). However, during presenter interactive mode 302 a presenter may not have exclusive control of the shared display as described in more detail below.

At the start up state 300, if user input is received selecting an audience role, and optionally if a verification step succeeds, the state transitions to a follow mode 310. In the follow mode 310 the device receives navigation data from the presenter host device, where the navigation data is details about how the content views are being navigated at a shared display controlled by the presenter host device. In the follow mode 310 the device uses the navigation data it receives to update the content views at a local display, local to the device, so that the local display device content views “follow” those of the shared display. During the follow mode 310 the device is unable to control the navigation at the shared display.

If user input is received during the follow mode 310, specifying a review mode 308, the device moves to the review mode 308. In the review mode 308 the device waits to receive user input and displays the content views at a local display associated with the device according to the user input and independently of the navigation data from the presenter host device about how the presenter is navigating the shared content views. In some examples, users are able to add/delete/edit bookmarks of content views and/or browse bookmarks when in review mode. During the review mode a cache of the content views at the device may be used to update a local display. During the review mode, if user input is received specifying the follow mode, the device transitions back to the follow mode 310. During the review mode 308 the device is unable to control the navigation at the shared display.

From review mode 308 it is possible to transition to an audience interactive mode 306 if conditions apply. During the audience interactive mode 306 user input received at the device (an audience device as the device has the audience role selected) is used to control navigation of the content views at the shared display. For example, by sending messages from the audience device to the presenter host device. More than one device may be in audience interactive mode 306 at the same time and in that case, the presenter host device updates the content views at the shared display on a first come first served basis. A local display at an audience device is updated so as to follow the shared display.

More detail about the conditions which apply in order to transition from review mode 308 to audience interactive mode 306 are now given. Suppose that at least one other device is in presenter interactive mode 302, where that other device is a member of the ongoing presentation. The conditions include that the audience device has received a message indicating that presenter interactive mode 302 is active at another device in the ongoing presentation. In some examples, the conditions include that user input is received at the audience device selecting the audience interactive mode 306.

Once in audience interactive mode 306 the state transitions back to either follow mode 310 or review mode in particular situations. For example, if there is no longer any other device (which is part of the ongoing presentation) that is in presenter interactive mode 302, then the device transitions back to review mode 308 automatically in some examples. In other examples it transitions back to follow mode 310 automatically in the case there is no longer any other device in presenter interactive mode 302. If user input is received at the audience device requesting transition to review mode 308 or to follow mode 310 then the state transitions accordingly.

It is also possible to transition directly from follow mode 310 to audience interactive mode 306 if conditions apply. For example, if the audience device has received a message indicating that presenter interactive mode 302 is active at another device in the ongoing presentation. In some examples, the conditions include that user input is received at the audience device selecting the audience interactive mode 306.

As mentioned above, more than one device may be in audience interactive mode 306 at the same time and in that case, the presenter host device updates the content views at the shared display on a first come first served basis with respect to navigation update request messages received from audience devices and presenter devices. It has been found that this type of control, using first come first served updates, works well in practice.

As mentioned above, communications devices are able to transition between modes designed for presenters and modes designed for audience members in a dynamic manner throughout a presentation.

The table below gives an example of functionality available during the modes of FIG. 3.

| | | | Presenter |
|---|---|---|---|
| | | | Interactive mode |
| | Presentation mode 304 | | 302 |
| Presenter | Presenter controls public display. | | Presenter allows |
| role | | | audience devices |
| selected | | | to choose between |
| | | | review mode and |
| | | | audience |
| | | | interactive mode . . . |
| | | | Audience |
| | | | Interactive mode |
| | Follow mode 310 | Review mode 308 | 306 |
| Audience | Presenter controls | Audience private | If an audience |
| role | public display and | review of the | device enters this |
| selected | audience private | content views at | mode after a |
| | display follows | the local display, | presenter device |
| | presenter control of | independent of | has allowed it, the |
| | public display. | the presenter | audience device |
| | | device(s), | controls the public |
| | | | display. |

In addition to the functionality mentioned above, a communications device which is in presenter role transitions simply and quickly to audience role (or vice versa) as a result of user input requesting the transition being received at the communications device. No other action is required in order to transition between the presenter role and audience role and in this way transitions between presenters and audience members occurs during presentations in an efficient manner.

FIG. 4 is a message sequence chart depicting an example message sequence between a presenter host device 200, an individual presenter device 224 (which communicates with the presenter host device) and an audience device 222. The vertical lines in FIG. 4 represent the individual presenter device 224, the presenter host device 200 and the audience device 222. In this example there is one audience device 222 although in practice there are more. The horizontal arrows represent messages sent between the devices in the directions indicated by the arrows. The relative vertical order of the horizontal arrows represents relative chronological order of the messages sent between the devices. The rectangular text boxes indicate method operations which occur at the devices.

The presenter host device discovers the audience device 222, optionally authenticates the audience device 222 and establishes a connection with the audience device 222 such as a transport control protocol (TCP) connection or any other wired or wireless connection. For example, the presenter host device discovers the audience device 222 by receiving a message from the audience device 222, by using an online service, by using near field communications, by using audio matching, by using quick response codes, by using wireless communication such as Bluetooth (trade mark), or in other ways. The presenter host device authenticates the audience device 222 by checking if the audience device 222 is a type of device suitable for an audience device 222 rather than another device emulating an audience device. For example, by using a quick response code, bar code, near field communications tag, audio tag, login process at an online service, personal identification number, or other authentication process. In some examples, the individual presenter device 224 becomes paired to the presenter host device using messages 402 such as through a personal identification number matched via a quick response code, or matched by a near field communications tag or matched by an audio match or in other ways. However, it is not essential for the individual presenter device 224 to be paired with the presenter host device.

The presenter host device sends one or more content views to the audience device 222 using messages 406 and to the individual presenter device using messages 404. The content views are cached 408 at the audience device 222 and the individual presenter device. In some examples, the content views are added to/edited/deleted using a content presentation component at the presenter host device. In this case the content views at the caches 408 are updated dynamically during the operation of the system to give a live update.

The presenter host device 200 enters a presentation mode (which is the presentation mode 304 of FIG. 3) 414 as a result of user input received at the presenter host device and/or the individual presenter device 224. The presenter host device outputs the content views to a shared display such as the lecture room display of FIG. 1A or the online lecture displays of FIG. 1B. The individual presenter device also enters the presentation mode 416 (which is the presentation mode 304 of FIG. 3). User input at the individual presenter device is communicated to the presenter host device 200 as indicated by the arrow from box 416 to box 414 and thus controls navigation of the content views at the shared display.

The audience device enters a follow mode 410 which is the follow mode 310 of FIG. 3.

The presenter host device 200 sends navigation data in message 412 to the audience device 222 and in message 418 to the individual presenter device. The navigation data is data specifying how the content views are navigated on the shared display by the presenter host device 200. The navigation data is used at the individual presenter device 224 to update a local display associated with the individual presenter device so that the local display content corresponds to (i.e. follows) the public view 420, that is, the content view at the shared display such as the online lecture room display or physical lecture room display. The navigation data is used at the audience device in the same way so that content views at a display local to the audience device correspond with (follow) the public view.

In some examples, the audience device 222 displays a private view at its associated local display. For example, to display content views, during review mode 308 of FIG. 3, from the cache of the audience device in an order which is independent of the order at the public display. Review mode 308 is not illustrated in FIG. 4 for clarity.

If user input is received at the individual presenter device 224 indicating a presenter interactive mode (302 of FIG. 3), the individual presenter device enters the presenter interactive mode 424 and sends a message to the presenter host device 200 which triggers the presenter host device 200 to enter the presenter interactive mode 426. The presenter host device 200 sends a message 428 to the audience device 222 indicating that the presenter interactive mode is active.

In some examples the presenter host device 200 sends the message 428 to a plurality of the audience devices 222 such as all the audience devices 222 it has discovered, authenticated and connected with, or audience devices which are part of the ongoing presentation controlled by the presenter host device.

The audience device 222 enters the audience interactive mode 430 (which is the audience interactive mode 306 of FIG. 3) either automatically as a result of receiving message 428 or after receiving user input in addition to message 428. The audience device 222 optionally sends message 432 to the presenter host device indicating that it has entered audience interactive mode. This message 432 may be omitted in the case that the audience device enters the audience interactive mode automatically as a result of receiving message 428.

User input is received at audience device 222 specifying how to navigate the public view of the content views. Thus the audience device 222 receives a request 434 to update the public view. The audience device sends a message 436 to the presenter host device 200 to update the public view according to the user input. The presenter host device receives message 436, checks that it is in the presenter interactive mode 302, and if so, updates the public view accordingly. As a result the navigation data is updated and sent to the audience device in message 438 and to the individual presenter device 224 as indicated. If the presenter host device receives message 436 when it is not in presenter interactive mode 302, it ignores message 436.

If user input is received at the individual presenter device 224 requesting a return to the presentation mode (304 of FIG. 3) a message is sent to the presenter host device. The presenter host device 200 returns to the presentation mode 442 and sends a message to the audience device 444 and to the individual presenter device indicating the change of mode.

If the presenter host device 200 receives navigation request messages from one or more audience devices during the presentation mode 304, it ignores the navigation request messages. In some examples, an audience device is prevented from sending navigation request messages unless it is in the audience interactive mode 306.

In the example of FIG. 4 an individual presenter device 224 is used by the presenter to communicate with the presenter host device 200 in order to control the system. However, it is not essential to use an individual presenter device 224. For example, a presenter is able to operate the presenter host device 200 directly as in the example of FIG. 1A. In this case the presenter host device 200 is used to switch between states/modes.

It is possible to modify the process of FIG. 4 to include the review mode according to the information given in FIG. 3.

FIG. 5 illustrates various components of an exemplary computing-based device 500 which are implemented as any form of a computing and/or electronic device, and in which embodiments of a presenter host device (200 of FIG. 2) or a communications device (216 of FIG. 2) are implemented in some examples.

Computing-based device 500 comprises one or more processors 502 which are microprocessors, controllers or any other suitable type of processors for processing computer executable instructions to control the operation of the device in order to carry out the method of FIG. 4. In some examples, for example where a system on a chip architecture is used, the processors 502 include one or more fixed function blocks (also referred to as accelerators) which implement a part of the method of FIG. 4 in hardware (rather than software or firmware). Platform software comprising an operating system 504 or any other suitable platform software is provided at the computing-based device to enable application software 506 to be executed on the device. A content view store 510 holds one or more content views and optionally navigation data. A content presentation component 202 and an interaction module 204 are present in the case that the computing device is a presenter host device as described with reference to FIG. 2. A navigation component 206 comprising a state machine 208 is present where the computing-based device 500 is either a presenter host device or a communications device such as an audience device.

The computer executable instructions are provided using any computer-readable media that is accessible by computing based device 500. Computer-readable media includes, for example, computer storage media such as memory 516 and communications media. Computer storage media, such as memory 516, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 516) is shown within the computing-based device 500 it will be appreciated that the storage is, in some examples, distributed or located remotely and accessed via a network or other communication link (e.g. using communication interface 518).

The computing-based device 500 also comprises an input/output controller 520 arranged to output display information to a display device 522 which may be separate from or integral to the computing-based device 500. The display information may provide a graphical user interface. The input/output controller 520 is also arranged to receive and process input from one or more devices, such as a user input device 524 (e.g. a mouse, keyboard, camera, microphone or other sensor). In some examples the user input device 524 detects voice input, user gestures or other user actions and provides a natural user interface (NUI). This user input may be used to change between interaction and review modes, to navigate content views, to privately review content views, to add and remove bookmarks and for other purposes. In an embodiment the display device 522 also acts as the user input device 524 if it is a touch sensitive display device. The input/output controller 520 outputs data to devices other than the display device in some examples, e.g. a locally connected printing device.

Any of the input/output controller 520, display device 522 and the user input device 524 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

A computing device comprising:

a navigation component configured to receive navigation data from a presenter host device, the navigation data being about navigation of a plurality of content views as part of a presentation of the content views being controlled by the presenter host device;

the navigation component being configured to enter an audience interactive mode when it receives data from the presenter host device indicating availability of the audience interactive mode; and

wherein the navigation component, is configured when in the audience interactive mode to send instructions to the presenter host device to control the navigation of the plurality of content views on the basis of user input received at the computing device.

The computing device described above wherein the navigation component is configured, when not in the audience interactive mode, to be unable to send instructions to the presenter host device to control the navigation of the plurality of content views.

The computing device described above wherein the navigation component is configured to exit the audience interactive mode when it receives instructions from the presenter host device to do so.

The computing device described above wherein the navigation component is configured to enter the audience interactive mode when it receives both the data from the presenter host device indicating availability of the audience interactive mode and user input accepting the audience interactive mode.

The computing device described above wherein the navigation component comprises a state machine comprising a follow mode and the audience interactive mode, and wherein the computing device comprises a local display controller configured to, during the follow mode, display the content views at a local display according to the presentation of the content views controlled by the presenter host device unless instructed otherwise by user input.

The computing device described above wherein the navigation component comprises a state machine with a review mode and wherein the computing device comprises a local display controller configured to, during the review mode, display the content views independently of the presenter host device.

The computing device described above comprising a local cache storing the content views and wherein the local display controller is configured to, during the review mode, display the content views from the local cache according to user input received at the device.

The computing device described above where the navigation component comprises a presenter role and an audience role, and where the navigation component is configured to transition between the presenter role and the audience role according to user input during the presentation of the content views.

A computing device comprising:

a content presentation component configured to control presentation of a plurality of content views to at least one audience device connected to the computing device using a wired or wireless communication link; and

a navigation component configured to send navigation data to the at least one audience device, the navigation data being about navigation of the plurality of content views;

the navigation component being configured to enter a presenter interactive mode according to user input, and when in the presenter interactive mode to receive instructions from the at least one audience device, and to control the navigation of the plurality of content views on the basis of the instructions from the at least one audience device.

The computing device described above wherein the navigation component is configured, when not in the presenter interactive mode, to exclusively control the navigation of the plurality of content views.

The computing device described above wherein the navigation component is configured, when not in the presenter interactive mode, to ignore navigation messages received from the at least one audience device.

The computing device described above wherein the navigation component is configured, when in the presenter interactive mode, to send a message to the at least one audience device, or to an individual presenter device in communication with the computing device, informing that an audience interactive mode is available.

The computing device described above wherein the navigation component is configured, when in the presenter interactive mode, to send a message to the at least one audience device, or to an individual presenter device in communication with the computing device, instructing exit of an audience interactive mode.

The computing device described above wherein the content presentation component comprises an interaction module which is an interface between the navigation component and the content presentation component.

A computer-implemented method comprising:

at a navigation component receiving navigation data from a presenter host device, the navigation data being about navigation of a plurality of content views as part of a presentation of the content views being controlled by the presenter host device;

entering an audience interactive mode when data is received from the presenter host device indicating availability of the audience interactive mode; and

when in the audience interactive mode, sending instructions to the presenter host device to control the navigation of the plurality of content views on the basis of user input received at the computing device.

The method described above comprising when not in the audience interactive mode, preventing instructions from being sent to the presenter host device to control the navigation of the plurality of content views.

The method described above comprising exiting the audience interactive mode when instructions are received from the presenter host device to do so.

The method described above comprising entering the audience interactive mode on receipt of both, the data from the presenter host device indicating availability of the audience interactive mode, and user input accepting the audience interactive mode.

The method described above comprising during a review mode, displaying the content views independently of the presenter host device unless instructions are received from the presenter host device.

The method described above comprising entering an audience role prior to entering the audience interactive mode, and transitioning between the audience role and a presenter role according to user input during the presentation of the content views.

A computing device comprising:

means for receiving navigation data from a presenter host device, the navigation data being about navigation of a plurality of content views as part of a presentation of the content views being controlled by the presenter host device;

means for entering an audience interactive mode when data is received from the presenter host device indicating availability of the audience interactive mode; and

means for ,when in the audience interactive mode, sending instructions to the presenter host device to control the navigation of the plurality of content views on the basis of user input received at the computing device.

The examples illustrated and described herein as well as examples not specifically described herein but within the scope of aspects of the disclosure constitute exemplary means for enabling audience devices to control a presentation of content views, and disabling this capability. For example, the elements illustrated in FIG. 2, such as when encoded to perform the operations illustrated in FIG. 4, constitute exemplary means for receiving navigation data from a presenter host device, exemplary means for entering an interaction mode, and exemplary means for sending instructions.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. Examples of tangible storage media include computer storage devices comprising computer-readable media such as disks, thumb drives, memory etc. and do not include propagated signals. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements. It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computing device comprising:
a navigation component configured to receive navigation data from a presenter host device, the navigation data being about navigation of a plurality of content views as part of a presentation of the content views being controlled by the presenter host device;
the navigation component being configured to enter an audience interactive mode when it receives data from the presenter host device indicating availability of the audience interactive mode; and
wherein the navigation component, is configured when in the audience interactive mode to send instructions to the presenter host device to control the navigation of the plurality of content views on the basis of user input received at the computing device.

2. The computing device of claim 1 wherein the navigation component is configured, when not in the audience interactive mode, to be unable to send instructions to the presenter host device to control the navigation of the plurality of content views.

3. The computing device of claim 1 wherein the navigation component is configured to exit the audience interactive mode when it receives instructions from the presenter host device to do so.

4. The computing device of claim 1 wherein the navigation component is configured to enter the audience interactive mode when it receives both the data from the presenter host device indicating availability of the audience interactive mode and user input accepting the audience interactive mode.

5. The computing device of claim 1 wherein the navigation component comprises a state machine comprising a follow mode and the audience interactive mode, and wherein the computing device comprises a local display controller configured to, during the follow mode, display the content views at a local display according to the presentation of the content views controlled by the presenter host device unless instructed otherwise by user input.

6. The computing device of claim 1 wherein the navigation component comprises a state machine with a review mode and wherein the computing device comprises a local display controller configured to, during the review mode, display the content views independently of the presenter host device.

7. The computing device of claim 6 comprising a local cache storing the content views and wherein the local display controller is configured to, during the review mode, display the content views from the local cache according to user input received at the device.

8. The computing device of claim 1 where the navigation component comprises a presenter role and an audience role, and where the navigation component is configured to transition between the presenter role and the audience role according to user input during the presentation of the content views.

9. A computing device comprising:
a content presentation component configured to control presentation of a plurality of content views to at least one audience device connected to the computing device using a wired or wireless communication link; and
a navigation component configured to send navigation data to the at least one audience device, the navigation data being about navigation of the plurality of content views;
the navigation component being configured to enter a presenter interactive mode according to user input, and when in the presenter interactive mode to receive instructions from the at least one audience device, and to control the navigation of the plurality of content views on the basis of the instructions from the at least one audience device.

10. The computing device of claim 9 wherein the navigation component is configured, when not in the presenter interactive mode, to exclusively control the navigation of the plurality of content views.

11. The computing device of claim 9 wherein the navigation component is configured, when not in the presenter interactive mode, to ignore navigation messages received from the at least one audience device.

12. The computing device of claim 9 wherein the navigation component is configured, when in the presenter interactive mode, to send a message to the at least one audience device, or to an individual presenter device in communication with the computing device, informing that an audience interactive mode is available.

13. The computing device of claim 9 wherein the navigation component is configured, when in the presenter interactive mode, to send a message to the at least one audience device, or to an individual presenter device in communication with the computing device, instructing exit of an audience interactive mode.

14. The computing device of claim 9 wherein the content presentation component comprises an interaction module which is an interface between the navigation component and the content presentation component.

15. A computer-implemented method comprising:
at a navigation component receiving navigation data from a presenter host device, the navigation data being about navigation of a plurality of content views as part of a presentation of the content views being controlled by the presenter host device;
entering an audience interactive mode when data is received from the presenter host device indicating availability of the audience interactive mode; and
when in the audience interactive mode, sending instructions to the presenter host device to control the navigation of the plurality of content views on the basis of user input received at the computing device.

16. The method of claim 15 comprising when not in the audience interactive mode, preventing instructions from being sent to the presenter host device to control the navigation of the plurality of content views.

17. The method of claim 15 comprising exiting the audience interactive mode when instructions are received from the presenter host device to do so.

18. The method of claim 15 comprising entering the audience interactive mode on receipt of both, the data from the presenter host device indicating availability of the audience interactive mode, and user input accepting the audience interactive mode.

19. The method of claim 15 comprising during a review mode, displaying the content views independently of the presenter host device unless instructions are received from the presenter host device.

20. The method of claim 15 comprising entering an audience role prior to entering the audience interactive mode, and transitioning between the audience role and a presenter role according to user input during the presentation of the content views.
